(19) United States
(12) Patent Application Publication
(10) Pub. No.: US 2009/0199159 A1
(43) Pub. Date: Aug. 6, 2009

(54) DECLARATIVE EXECUTION CONTEXT SPLITTING

(75) Inventors: Henricus Johannes Maria Meijer, Mercer Island, WA (US); Brian Beckman, Newcastle, WA (US); John Wesley Dyer, Monroe, WA (US); Jeffrey van Gogh, Redmond, WA (US); Benjamin Livshits, Kirkland, WA (US); Dragos A. Manolescu, Kirkland, WA (US); Danny van Velzen, Redmond, WA (US); Harish V. Kantamneni, Redmond, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/023,041

(22) Filed: Jan. 31, 2008

(51) Int. Cl. G06F 9/44

(52) U.S. Cl. 717/114

(57) ABSTRACT

Various technologies and techniques are disclosed for enabling code to be executed on one or more execution contexts based upon declarative annotations contained in the code or other locations. An annotation associated with a region of code is located. The annotation specifies information about an execution context where the region of code should be executed. A caller proxy is generated that is responsible for calling a callee adapter to execute the region of code. The callee adapter is generated that is responsible for receiving a call from the caller proxy and for dispatching a call to the region of code at the execution context. At runtime, the caller proxy receives a request to call the region of code and sends an execution request to the callee adapter. The callee adapter receives the execution request and dispatches a call to an executable version of the region of code.

### BACKGROUND

Software applications are written using one or more programming languages. To create a software application, a developer writes the code that contains the instructions that the computer should perform. Some types of code may be compiled into an executable file, while in other types of code may be interpreted at runtime. In either scenario, the code is transformed at some point into machine instructions that the computer can execute.

Computers are becoming more and more powerful every day, and can communicate with one another over different communication channels, such as company networks or the Internet. This increase in computing power and networking between computers has enabled software developers to write software applications that execute across multiple computer locations. However, development of such distributed applications is difficult due to the complexity of the task. Part of the complication has to do with the numerous protocols, languages, and technologies that need to be mastered individually and then used in combination with each other in order to create a distributed application.

### SUMMARY

Various technologies and techniques are disclosed for enabling code to be executed on one or more execution contexts based upon annotations contained in the code or other locations. An annotation associated with a region of code is located. The annotation specifies information about an execution context where the region of code should be executed. A caller proxy is generated that is responsible for calling a callee adapter to execute the region of code. The callee adapter is generated that is responsible for receiving a call from the caller proxy and for dispatching a call to the region of code on the execution context. At runtime, the caller proxy receives a request to call the region of code and sends an execution request to the callee adapter. The callee adapter receives the execution request and dispatches a call to an executable version of the region of code. In one implementation, the execution environment is loaded in the callee adapter.

In one implementation, a method for invoking a call to a region of code through a callee adapter from a caller proxy is described. A request is received at a caller proxy to call a region of code. The region of code has a caller proxy and a callee adapter that were generated based upon at least some information specified in an annotation to the region of code to indicate that the region of code should be executed on a certain execution context. A call to the region of code is located in the caller proxy. An execution request for the region of code is passed to the callee adapter over a communication channel. The execution request contains a request that the callee adapter execute the region of code at the execution context.

In another implementation, a method for invoking a call to a region of code from a callee adapter upon request from a caller proxy is described. An execution request is received at a callee adapter from a caller proxy to execute a region of code. The caller proxy and the callee adapter were generated based upon at least some information specified in an annotation to the region of code to indicate that the region of code should be executed on an execution context. A call entry for the region of code is located in the callee adapter. A call is dispatched to an executable version of the region of code based upon information in the call entry.

This Summary was provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a diagrammatic view of a declarative execution context splitting system of one implementation.

FIG. 2 is a process flow diagram for one implementation illustrating the stages involved in splitting up and/or transforming code into new units of code such that they can be executed in the execution context(s) designated in the annotation(s).

FIG. 3 is a process flow diagram for one implementation illustrating the stages involved in generating caller proxies and callee adapters.

FIG. 4 is a process flow diagram for one implementation illustrating the stages involved in using caller proxies and callee adapters to communicate at runtime.

FIG. 5 is a process flow diagram for one implementation illustrating the stages involved in a caller proxy sending an execution request to a callee adapter.

FIG. 6 is a process flow diagram for one implementation illustrating the stages involved in a callee adapter executing a region of code on an execution context based upon an execution request from a caller proxy.

FIG. 7 is a process flow diagram for one implementation illustrating the stages involved in using a substitute callee adapter.

FIG. 8 is a diagrammatic view of a computer system of one implementation.

### DETAILED DESCRIPTION

The technologies and techniques herein may be described as techniques for enabling code to be executed on one or more execution contexts based upon annotations contained in the code or other locations, but the technologies and techniques also serve other purposes in addition to these. In one implementation, one or more of the techniques described herein can be implemented as features within a software development program such as MICROSOFT® VISUAL STUDIO®, or from any other type of program or service that manages one or more parts of the software development and/or execution process.

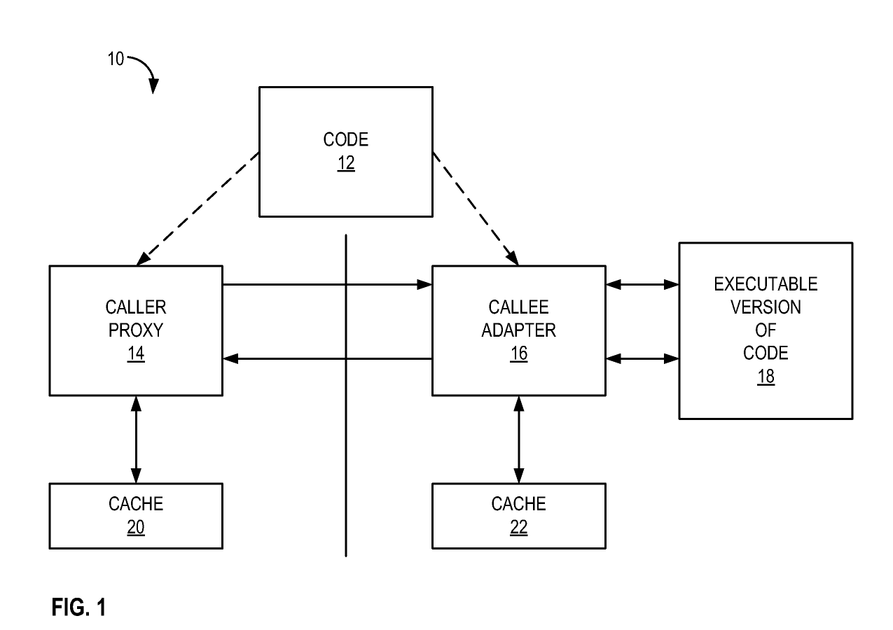

FIG. 1 is a diagrammatic view of a declarative execution context splitting system 10 of one implementation. Code 12 is created using one or more software development tools. The term “code” as used herein is meant to include source code, an intermediate language version of the source code, or any other representation of code for controlling a computer that can be transformed into machine or other instructions for execution on a computer. The code 12 or some other data source (such as a configuration file) is marked with one or more annotations by a software developer or programmatically. In one implementation, these annotations allow the software developer (or other user or program) to write code in a simpler fashion that is more like code that would normally just be for a single execution context (or tier), but that actually ends up being executed in multiple contexts. This is achieved by specifying different execution contexts on which different portions of the code should run. In other words, the software developer or automated program does not have to bother with writing the code to implement the execution of the program across the different execution contexts, as the techniques described herein are used to generate the necessary infrastructure for allowing the proper communications to take place across these execution contexts.

An annotation associated with a particular region of code indicates that the region of code should be executed in a certain execution context (or more than one execution context). The term “region of code” as used herein is meant to include one or more contiguous or non-contiguous portions of code. A few non-limiting examples of a region of code can include a class, method, or other grouping of code. The term “execution context” as used herein is meant to include a context or location upon which an executable version of code can be run. Examples of execution contexts include a different computer, processor, thread, core on a processor, and so on. In one implementation, the annotation contains complete details about the execution context where the region of code should be executed.

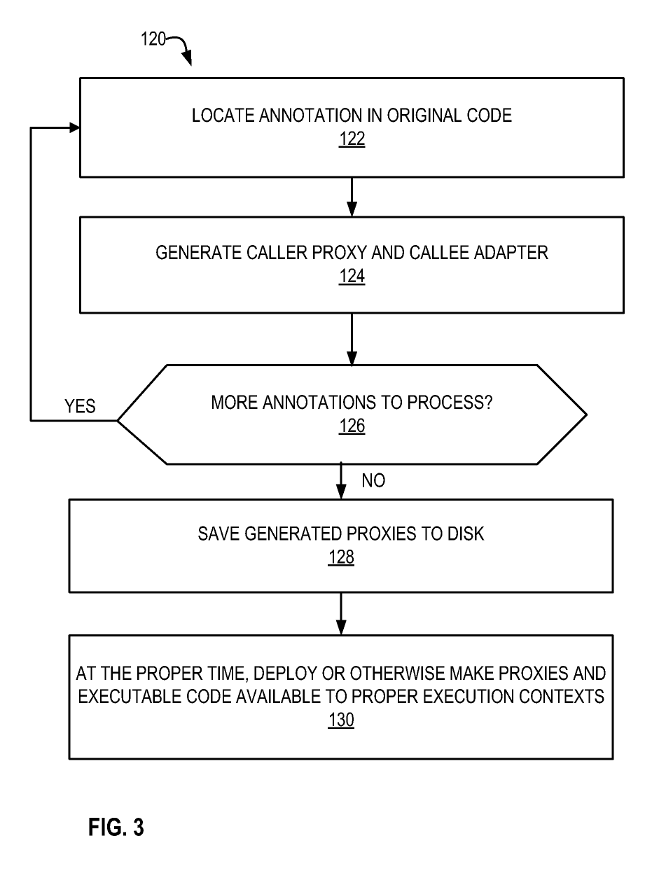

In another implementation, the annotation is just an indirect reference or other indicator to designate that the region of code should be executed elsewhere. Other information, such as configuration data sources (files, data stores, etc.) can then be consulted at compile time and/or at runtime to determine this exact execution context. As another example, decisions about where to execute the region of code can be made a runtime by a load balancer based upon system availability. As yet another example, a setting or other option can be provided to specify when the annotations should be ignored altogether so that the splitting processes described herein are ignored and the application is simply run on a single tier or execution context, such as for testing. In yet another implementation, all or partial information about the execution context can be provided in the annotation, but information from other sources can still be consulted for further details. Other variations are also possible. The process of generating the caller proxies and callee adapters is described in further detail in FIG. 3.

The code 12 is analyzed and a caller proxy 14 and callee adapter 16 are generated for each annotation that specifies an execution context on which the particular region of code should be executed. The term “caller proxy” as used herein is meant to include a program, service, or other executable logic that is responsible for receiving and forwarding a request to execute a region of code to a callee adapter. The term “callee adapter” as used herein is meant to include a program, service, or other executable logic that is responsible for receiving a request to execute a region of code and for dispatching a call to an executable version of the region of code. With respect to FIG. 1, this means that caller proxy 14 is responsible for receiving a request to call the region of code (e.g. a particular method, etc.) and for opening or re-using a communication channel with the callee adapter 16 to send an execution request to the callee adapter 16. The callee adapter 16 then receives the execution request and dispatches a call to an executable version of the code 18. The result of the execution of the code is then returned from the callee adapter 16 to the caller proxy 14.

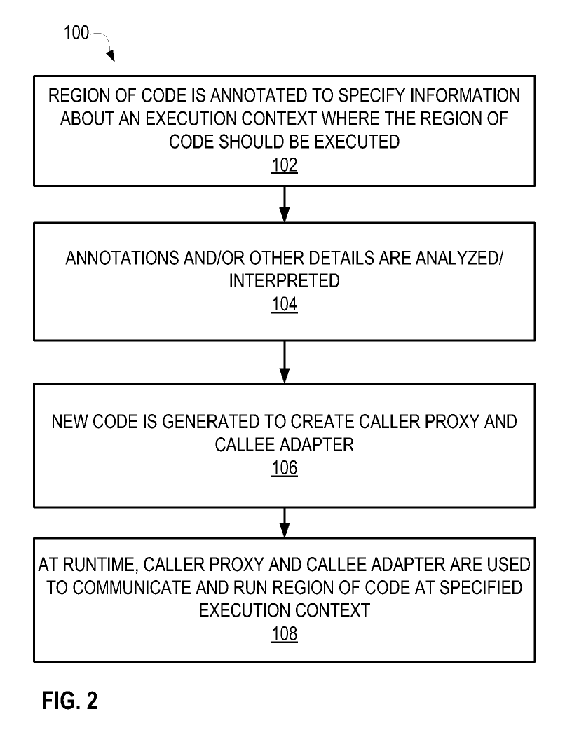

In one implementation, a caller-side cache 20 is used by the caller proxy 14 to allow the caller proxy 14 to identify the objects for which execution is being requested. In other words, the caller-side cache 20 allows the caller proxy 14 to keep track of an identifier that allows a particular object or instance of that object to be identified on other execution contexts. So when the caller proxy 14 receives communications back from the callee adapter 16, the caller proxy 14 can use the caller-side cache 20 to determine what object (e.g. method or other region of code) is being referenced. Similarly, a callee-side cache 22 is used by the callee adapter 16 to keep track of an identifier or other information that allows a particular object or instance of that object to be identified by the callee adapter. These and other details regarding declarative execution context splitting system 10 will now be described in further detail in FIGS. 2-7.

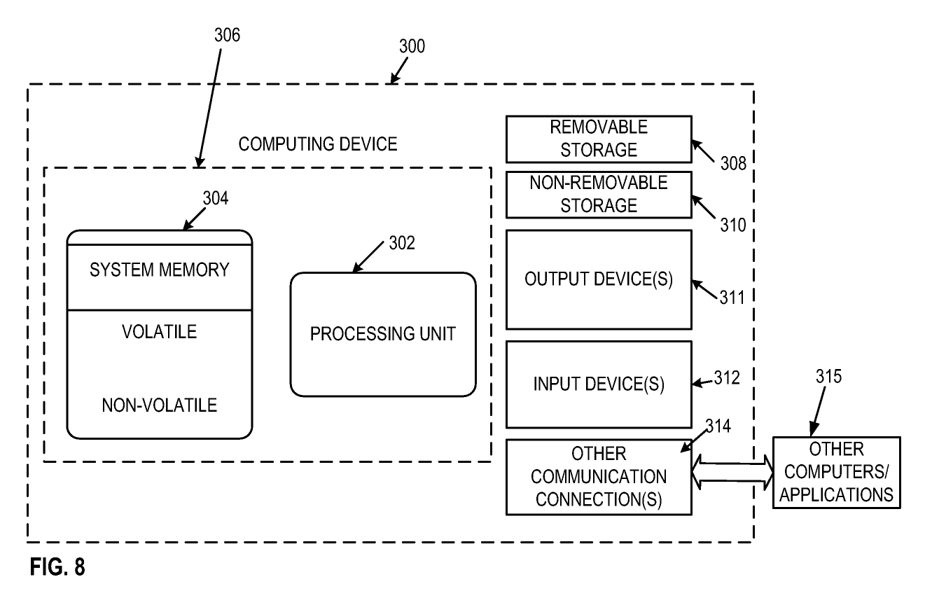

Turning now to FIGS. 2-7 with continued reference to FIG. 1, the stages for implementing one or more implementations of declarative code splitter system 10 are described in further detail. In some implementations, the processes of FIG. 2-7 are at least partially implemented in the operating logic of computing device 300 (of FIG. 8).

FIG. 2 is a process flow diagram 100 that illustrates one implementation of the stages involved in splitting up and/or transforming code into one or more new units of code such that they can be executed in the execution context(s) designated in the annotation(s). The original code is annotated (such as by a software developer or programmatically) to specify information about an execution context where the region of code should be executed (stage 102). In one implementation, the annotation can include details about the actual location of the execution context, such as a file or network path. In another implementation, the information can simply be an indicator or other identifier that specifies that the region of code should be run elsewhere, and that the system should look in a configuration or other location to get additional details on the execution context.

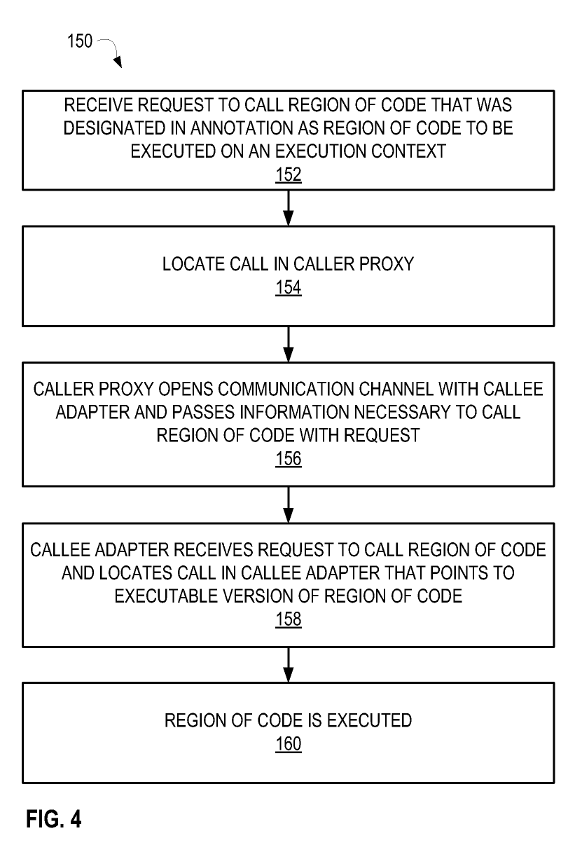

The annotations and/or other details are then analyzed and/or interpreted (stage 104). In other words, the code (source code, intermediate version of the code, etc.) is parsed to identify the annotations that specify one or more execution contexts for executing the code. New code is then generated to create a caller proxy and a callee adapter (stage 106), as described in further detail in FIG. 3. At runtime, the caller proxy and callee adapter are used to communicate and run the original code (or some transformed version of the original code) at a specified execution context (stage 108), as described in further detail in FIGS. 4-6.

For the sake of illustration, some exemplary code is shown below to provide an example of how a method, class, or other region of code can be annotated to indicate that it should be executed on a certain execution context.

```
using System;
using Library.MultiTier;
class Program
{
  static void Main( )
  {
    var c = new C( );
    c.y = 3;
    Console.WriteLine(c.y);
    c.P = 1;
    Console.WriteLine(c.F(typeof(Program).Name));
    c.P++;
    c.y = c.P * c.y;
    Console.WriteLine(c.P);
    Console.WriteLine(c.y);
  }
}
```

[RunAtServer(“http://localhost:8081”)]

```
class C
{
  public int F(string s)
  {
    if (s == null)
      return 0;
    return s.Length;
  }
  int x = 0;
  public int P
  {
    get { return x; }
    set { x = value; }
  }
  public int y = 0;
}
```

In the above code sample, notice how the entire Class called C has been decorated with an annotation (e.g. attribute) called RunAtServer, where the argument within double quotes represents the server's URI.

[RunAtServer(“http://localhost:8081”)]

The RunAtServer annotation in this example indicates that all of the methods contained in the Class C should be executed on a server at the specified location. This is just a non-limiting example, and various other types of annotations could be used in other implementation, such as for smaller or larger regions of code, as described previously. For example, the annotation could just contain an indirect reference or other indicator to designate that the region of code should be executed elsewhere. In such a scenario, the details surrounding the execution context could be located in a configuration or other file or data store that should be checked to get the exact execution context. Other variations are also possible.

FIG. 3 is a process flow diagram 120 that illustrates one implementation of the stages involved in generating caller proxies and callee adapters. The declarative code splitter system locates annotations in the original code (stage 122). The system generates the caller proxy and the callee adapter (stage 124). While there are more annotations to process (decision point 126), then stages 122 and 124 are repeated to generate the proxy and adapter for the next annotation. The proxies and adapters can be generated in any of a number of orders, such as per annotation, all callee adapters first, all caller proxies first, and so on. Once all of the proxies and adapters are generated for the one or more annotations, the proxies and adapters are saved to disk (stage 128). At the proper time, the proxies, adapters, and executable code are made available to the proper execution contexts (stage 130). The proper time could be at deployment time, immediately after creating the proxies and adapters, or some other suitable time prior to execution. As part of this deployment process, each proxy and/or adapter is copied or otherwise made available to the respective execution context. In other words, each callee adapter is made available to the respective callee machine or execution context, and each caller proxy is made available to the respective caller machine or execution context. An executable version of the original code (or some later transformed version of that code) is copied to the callee machine or otherwise made accessible to the callee machine (stage 128), such as from another location.

To further illustrate the concepts of FIG. 3, some examples will be shown of a caller proxy and a callee adapter. These examples correspond to the sample code introduced earlier when describing an example of an annotation. The following code is an example of what the caller proxy might look like for the previous code segment, with the entire Class C designated to run on a specific execution context.

[RunAtServer(“http://localhost:8081”)]

```
public class C
{
  // Fields
  private Guid _instance;
  // Methods
  public C( )
  {
    object[ ] parameters = new object[0];
    Guid? instance = null;
    this._instance = Proxy.Call<Guid>(“http://localhost:8081/C.agi”,
5, instance, parameters);
  }
  public int F(string s)
  {
    object[ ] parameters = new object[ ] { s };
    return Proxy.Call<int>(“http://localhost:8081/C.agi”, 2, new
Guid?(this._instance), parameters);
  }
  // Properties
  public int P
  {
    get
    {
      object[ ] parameters = new object[0];
      return Proxy.Call<int>(“http://localhost:8081/C.agi”, 3, new
Guid?(this._instance), parameters);
    }
    set
    {
      object[ ] parameters = new object[ ] { value };
      Proxy.Call(“http://localhost:8081/C.agi”, 4, new
Guid?(this._instance), parameters);
    }
  }
  public int y
  {
    get
    {
      object[ ] parameters = new object[0];
      return Proxy.Call<int>(“http://localhost:8081/C.agi”, 0, new
Guid?(this._instance), parameters);
    }
    set
    {
      object[ ] parameters = new object[ ] { value };
      Proxy.Call(“http://localhost:8081/C.agi”, 1, new
Guid?(this._instance), parameters);
    }
  }
}
```

As shown above, each portion of the original code for Class C has been modified to include code for calling the callee adapter for each line of code.

The following code is an example of what the callee adapter for the Method C might look like in the hypothetical example.

```
private class _Service : Service<C>
{
  // Methods
  /* private scope */ _Service( )
  {
  }
  protected override void ProcessMethod(Service<C>.Call call)
  {
    switch (call.GetMethod( ))
    {
      case 0:
        call.Return<int>(call.GetInstance( ).y);
        break;
      case 1:
        call.GetInstance( ).y = call.GetParameter<int>(0);
        break;
      case 2:
        call.Return<int>(call.GetInstance( ).F(call.GetParameter
        <string>(0)));
        break;
      case 3:
        call.Return<int>(call.GetInstance( ).P);
        break;
      case 4:
        call.GetInstance( ).P = call.GetParameter<int>(0);
        break;
      case 5:
        call.Return<Guid>(call.AddInstance(new C( )));
        break;
      default:
        throw new InvalidMethodException( );
    }
  }
}
```

As shown in the callee adapter example code above, each of the cases in the switch statement correspond to a particular region of the code in the original code. For example, case statement 1 corresponds to the region of code associated with property Y. Case statement 2 corresponds to the region of code associated with function F, and so on. Each case statement is then responsible for calling the executable version of the original code for Class C. These are just hypothetical examples, and numerous other styles and formats for creating caller proxies and callee adapters could also be used.

Now that a background has been given on the generation of caller proxies and callee adapters, the runtime use of the proxies will now be described in further detail. FIG. 4 is a process flow diagram 150 that illustrates one implementation of the stages involved in using caller proxies and callee adapters to communicate at runtime. A request is received by the caller proxy to call a region of code that was designated in the annotation as a region of code to be executed on an execution context (stage 152). For example, when a program is being executed that reaches a point where the region of code needs executed, then the caller proxy can receive the request to call the region of code. A call to the region of code is located in a caller proxy (stage 154). The caller proxy then opens a communication channel with callee adapter (if a communication channel is not already open) and passes information necessary to call the region of code with the execution request (stage 156). In one implementation, the communication channel is compressed and/or encrypted. In one implementation, the caller proxy determines what type of communication channel to open by deciding dynamically or by accessing some configuration in a configuration file or other data source. In another implementation, the caller proxy can reuse existing communication channels that it has opened previously or that are already available on the computing device.

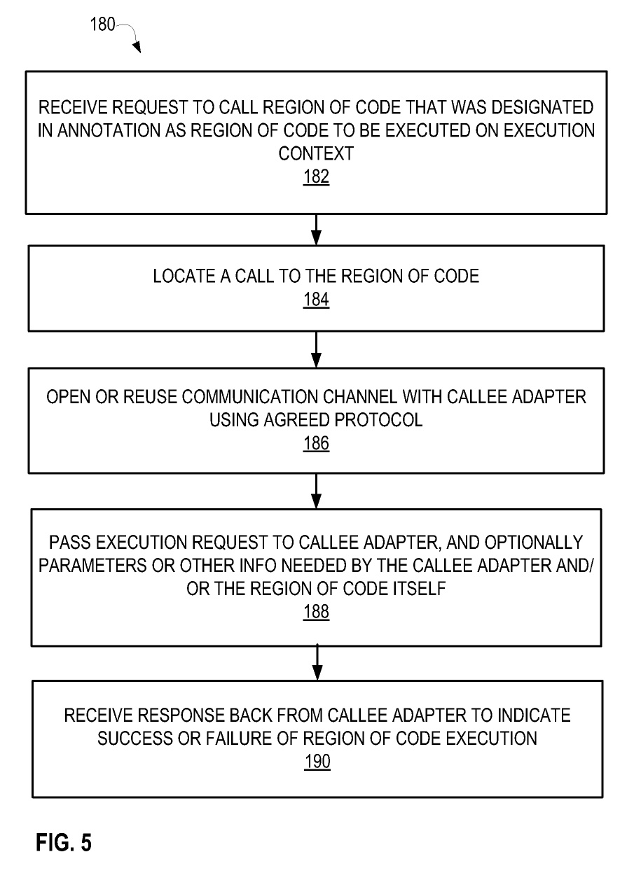

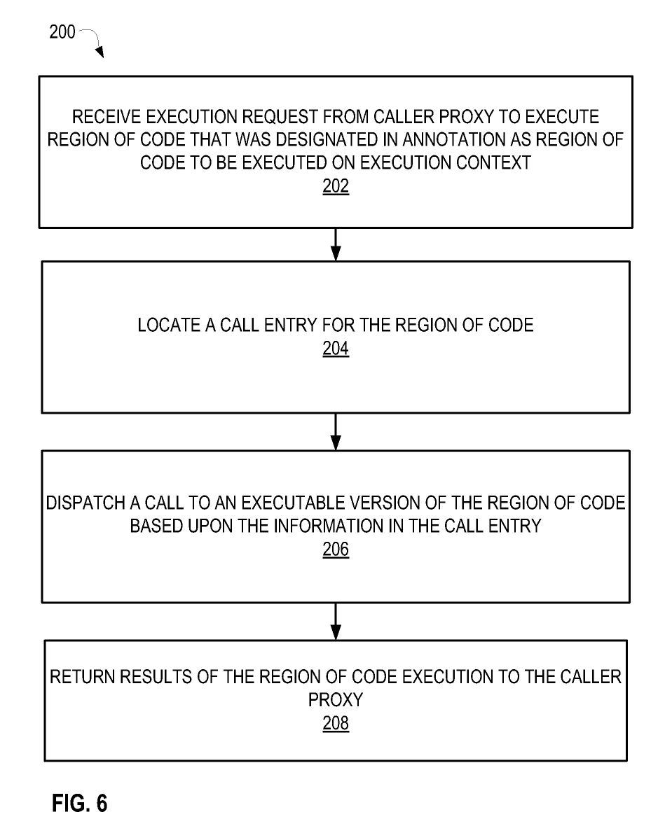

The callee adapter then receives the request to call the region of code and locates a call in the callee adapter that points to executable version of the region of code (stage 158). An executable version of the region of code is then executed (stage 160). These stages are described in further detail in FIGS. 5 and 6, which describe the perspectives of the caller side and the callee side, respectively.

FIG. 5 is a process flow diagram 180 for one implementation illustrating the stages involved in a caller proxy sending an execution request to a callee adapter. A request is received to call a region of code that was designated in an annotation as a region of code to be executed on an execution context (stage 182). A call to the region of code is located in the caller proxy (stage 184). A communication channel is opened or reused with the callee adapter using an agreed protocol (stage 186). An execution request is passed to the callee adapter, along with any parameters or other information needed by the callee adapter and/or the region of code itself (stage 188). In one implementation, the amount of information being passed to the callee adapter can be reduced based upon an analysis of what information is actually needed by the callee adapter. As one non-limiting example, if only a portion of the fields of a class will be used, then just those fields could to be transferred to the callee adapter, as opposed to all the fields. In one implementation, the execution request includes a region identifier for allowing the callee adapter to identify the region of code. A response is later received back from the callee adapter to indicate a success or failure of the region of code execution (stage 190), and/or to return other information useful to the caller proxy, as described in further detail in FIG. 6.

FIG. 6 is a process flow diagram 200 for one implementation illustrating the stages involved in a callee adapter executing a region of code on an execution context based upon an execution request from a caller proxy. The callee adapter receives the execution request from the caller proxy to execute the region of code that was designated in the annotation as a region of code to be executed on the execution context (stage 202). A call entry for the region of code is located in the callee adapter (stage 204). A call is dispatched to an executable version of the region of code based upon information in the call entry (stage 206). The results of the region of code execution (e.g. success, failure, etc.) are then returned to the caller proxy (stage 208). In one implementation, optional data can also be returned, such as an output parameter that is returned from the executed region of code, or some data being returned from the callee adapter that is useful for communication between the callee adapter and the caller proxy. One non-limiting example of data that could be returned includes an identifier specific to the callee-side cache for referencing instances of the region of code that can be used for future calls. The callee-side cache was described in detail in FIG. 1. Another non-limiting example of the data that could be returned includes routing information that specifies how the call was routed for execution or should be routed for future communication. Numerous other types of data could also be returned.

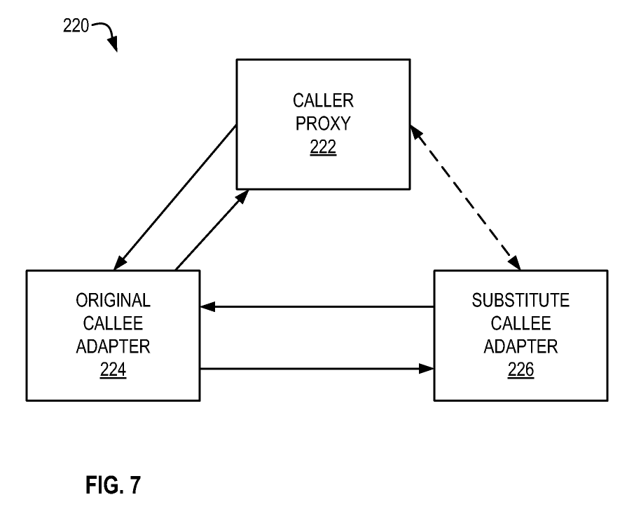

Turning now to FIG. 7, a diagrammatic view 220 is shown for one implementation illustrating the use of a substitute callee adapter 226. A caller proxy 222 is used to call an original callee adapter 224 to execute a region of code as described in the earlier figures herein. The original callee adapter 224 then calls a substitute callee adapter 226 to handle the execution request. In one implementation, the original callee adapter 224 just temporarily calls the substitute callee adapter 226 for a period of time that the substitute callee adapter 226 is better suited to handle the execution of the region of code. This could be due to the substitute callee adapter 226 having more system resources available, or due to other factors. In another implementation, the original callee adapter 224 can actually indicate to the caller proxy 222 that the calls should be re-directed “directly” to the substitute callee adapter 226. In such a scenario, the caller proxy 222 then proceeds with communicating directly with the substitute callee adapter 226, instead of first going through the original callee adapter 224. In other words, in such a scenario, the original callee adapter 224 serves as a middle man or broker that initiates the communication between the caller proxy 222 and the substitute callee adapter 226 and then gets out of the way. In one implementation, caller proxy 222 can decide to call callee adapter 226 based on various pieces of information, such as configuration data, information received about the communication channel (bandwidth, latency, connectivity issues), information received from original callee adapter 224, and/or other types of information.

As shown in FIG. 8, an exemplary computer system to use for implementing one or more parts of the system includes a computing device, such as computing device 300. In its most basic configuration, computing device 300 typically includes at least one processing unit 302 and memory 304. Depending on the exact configuration and type of computing device, memory 304 may be volatile (such as RAM), non-volatile (such as ROM, flash memory, etc.) or some combination of the two. This most basic configuration is illustrated in FIG. 8 by dashed line 306.

Additionally, device 300 may also have additional features/functionality. For example, device 300 may also include additional storage (removable and/or non-removable) including, but not limited to, magnetic or optical disks or tape. Such additional storage is illustrated in FIG. 8 by removable storage 308 and non-removable storage 310. Computer storage media includes volatile and nonvolatile, removable and non-removable media implemented in any method or technology for storage of information such as computer readable instructions, data structures, program modules or other data. Memory 304, removable storage 308 and non-removable storage 310 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 300. Any such computer storage media may be part of device 300.

Computing device 300 includes one or more communication connections 314 that allow computing device 300 to communicate with other computers/applications 315. Device 300 may also have input device(s) 312 such as keyboard, mouse, pen, voice input device, touch input device, etc. Output device(s) 311 such as a display, speakers, printer, etc. may also be included. These devices are well known in the art and need not be discussed at length here. In one implementation, computing device 300 includes one or more portions of declarative code splitter system 10 that was described in the earlier figures.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. All equivalents, changes, and modifications that come within the spirit of the implementations as described herein and/or by the following claims are desired to be protected.

For example, a person of ordinary skill in the computer software art will recognize that the examples discussed herein could be organized differently on one or more computers to include fewer or additional options or features than as portrayed in the examples.

What is claimed is:

1. A computer-readable medium having computer-executable instructions for causing a computer to perform steps comprising:
locating an annotation that is associated with a region of code, the annotation specifying information about an execution context where the region of code should be executed;
generating a caller proxy that is responsible for calling a callee adapter to execute the region of code; and
generating the callee adapter that is responsible for receiving a call from the caller proxy and for dispatching a call to the region of code at the execution context.

2. The computer-readable medium of claim 1, further having computer-executable instructions for causing a computer to perform steps comprising:
repeating the locating, generating the caller proxy, and generating the callee adapter steps for a plurality of annotations.

3. The computer-readable medium of claim 1, wherein the generating the caller proxy step is operable to make the caller proxy accessible to a caller machine.

4. The computer-readable medium of claim 1, wherein the generating the callee adapter step is operable to make the callee adapter accessible to a callee machine.

5. The computer-readable medium of claim 4, wherein the generating the callee adapter step is further operable to load an executable version of the region of code onto the callee machine.

6. The computer-readable medium of claim 1, wherein the caller proxy is operable to communicate over a communication channel with the callee adapter and send an execution request to the callee adapter.

7. The computer-readable medium of claim 1, wherein one or more configuration data sources are considered in addition to the annotation to determine how to generate the caller proxy and the callee adapter.

8. The computer-readable medium of claim 1, wherein the execution context represents a computer on which the region of code should run.

9. The computer-readable medium of claim 1, wherein the execution context represents a thread on which the region of code should run.

10. The computer-readable medium of claim 1, wherein the execution context represents a core of a multi-core processor on which the region of code should run.

11. The computer-readable medium of claim 1, wherein the execution context represents a processor on which the region of code should run.

12. A method for invoking a call to a region of code through a callee adapter from a caller proxy comprising the steps of:
receiving a request to call a region of code, the region of code having a caller proxy and a callee adapter that were generated based upon at least some information specified in an annotation to the region of code to indicate that the region of code should be executed on an execution context;
locating a call to the region of code in the caller proxy; and
passing an execution request for the region of code to the callee adapter over a communication channel, the execution request containing a request that the callee adapter execute the region of code at the execution context.

13. The method of claim 12, wherein a region identifier is passed along with the execution request so that the region of code can be identified by the callee adapter and then executed on the execution context.

14. The method of claim 13, wherein an instance parameter is passed along with the execution request to allow the callee adapter to identify an instance of the region of code that should be executed on the execution context.

15. The method of claim 12, further comprising the steps of:
receiving a response back from the callee adapter to indicate a result of the execution request.

16. The method of claim 12, wherein additional communication information is accessed to determine how to open the communication channel with the callee adapter prior to passing the execution request.

17. The method of claim 12, wherein an object cache is maintained by the caller proxy to allow the caller proxy to identify the region of code.

18. A method for invoking a call to a region of code from a callee adapter upon request from a caller proxy comprising the steps of:
receiving an execution request at a callee adapter from a caller proxy to execute a region of code, the caller proxy and the callee adapter having been generated based upon at least some information specified in an annotation to the region of code to indicate that the region of code should be executed on an execution context;
locating a call entry for the region of code in the callee adapter; and
dispatching a call to an executable version of the region of code based upon information in the call entry.

19. The method of claim 18, wherein after receiving the execution request at the callee adapter, a substitute callee adapter is identified, the substitute callee adapter is forwarded the execution request from the callee adapter, and the locating and dispatching steps are then performed by the substitute callee adapter.

20. The method of claim 18, wherein the execution request also includes any parameters needed by the executable version of the region of code for execution.
